(19) United States
(12) Patent Application Publication
(10) Pub. No.: US 2015/0313264 A1
(43) Pub. Date: Nov. 5, 2015

(54) Filled food product and method of producing such food product

(71) Applicant: BERTAGNI 1882 SPA, Arcugnano (vi) (IT)

(72) Inventor: Enrico Bolla, Grezzana (VR) (IT)

(73) Assignee: BERTAGNI 1882 SPA, Arcugnano (VI) (IT)

(21) Appl. No.: 14/440,123

(22) PCT Filed: Feb. 7, 2014
(86) PCT No.: PCT/IB2014/058847

§ 371 Date: May 1, 2015

(30) Foreign Application Priority Data
Feb. 7, 2013 (IT) VI2013A000024

(51) Int. Cl. A23L 1/16

(52) U.S. Cl. CPC A23L 1/1606; A23V 2002/00

(57) ABSTRACT

A filled food product, such as Italian dumplings known as ravioli, cappelletti, tortelli, panzerotti and the like, includes an envelope made of pasta, enclosing therein a filling made of edible raw materials. The envelope has at least one sheet of fresh pasta and the filling includes at least one first dose of a first component and at least one second dose of a second component other than the first component. The doses are distinct and both enclosed within the envelope. The envelope is made up of a lower layer and an upper layer, the layers being in mutually facing relationship and joined together along a substantially continuous peripheral edge having a predetermined shape. The envelope is closed along the peripheral edge in substantially liquid-tight fashion.

### FIELD OF THE INVENTION

The present invention generally finds application in the field of food products and particularly relates to a filled food product, such as Italian dumplings known as ravioli, cappelletti, tortelli, panzerotti and the like.

The invention also relates to a method of producing filled food products as mentioned above.

### BACKGROUND ART

Food products are known in the art, which comprise an envelope of pasta enclosing a filling therein.

These products are typical products of Italian gastronomy and the filling may be made of several types of ingredients such as, for instance, meat, fish, cereals, vegetables, cheese, protein- or fat-based substances or the like.

According to their shapes, these filled food products are known as ravioli, tortellini, cappelletti, panzerotti, although many other shapes exist for filled food products from regional Italian and foreign gastronomic traditions.

Generally, the filling is laid on a sheet of dough, which is later closed on itself or with another sheet to cover and wrap the filling.

Filled food products are known, which have a filling made of predetermined doses of first and second food components in a raw or cooked state.

Particularly, the recipes of certain types of filled products require the two food components of the filling to be separate and not mix together during filling. This will provide filled food products prepared in strict compliance with the original recipes, and will allow the consumer to appreciate the taste obtained by the combination of the individual tastes of each food component in the filling.

One example of these food products is disclosed in EP 475 911, which comprises an envelope made of two distinct pockets or shells enclosing differentiated components or ingredients, and thus designed to remain separate and not contact each other.

One drawback of these known products is that they are actually formed of two ravioli of different tastes, whereby they cannot be tasted at the same time, unless they are joined and ingested together. Nevertheless, in this case the amount of pasta increases and at least partially dilutes the tastes of the individual ingredients, in addition to increasing the percentage of carbohydrates relative to proteins.

A further example of food products having multiple fillings is disclosed in WO2011/117641, which describes a savory food product composed of an envelope or outer tubular body made of pasta dough with one or more channels in which different food substances are held. The method of making the product, e.g. in the form of a sausage roll, comprises coextruding the body made of pasta with a sauce and with minced meat disposed in respective concentric or radially staggered channels.

In this product fresh pasta cannot be used for the body, and the components of the fillings must undergo a thermal cooking treatment before being extruded into their respective channels.

Furthermore, the method only provides cylindrical envelopes and fillings, in which the first and second components are disposed in respective coaxial or parallel channels. In practice, the product is tasted in sliced form, and resembles more a sausage than a pasta product.

US2012/0121169, on which is based the preamble of the attached claim 1, discloses an artistic pasta generally shaped as ravioli comprising one upper carrier layer made of multi-colored and multi-layered pasta dough and a lower layer joint to the upper carrier layer along a peripheral edge to form a closed envelope which encloses a filling. The filling is made of a plurality of ingredients or combination of ingredients but is unitary and with no multiple dose so that the taste and flavor cannot be variegated.

U.S. Pat. No. 4,711,165 discloses a precooked lasagna designed to be frozen and formed by a pasta mixture of semolina and egg which is extruded to form noodles or strips with scalloped edges. A filler is deposited between the various noodles and the strips are superimposed to form a lasagna sandwich which can be folded to assume an “e” section. Nevertheless the noodles are not joined together but leave the scalloped edges open so that the sauce can migrate between the strips despite the filler. The filler can have any composition but is of a single type thus reducing the choice and taste of the precooked lasagna.

### DISCLOSURE OF THE INVENTION

The object of the present invention is to overcome the above mentioned drawbacks, by providing a filled food product that has a high organoleptic value and is relatively cost-effective.

A particular object of the present invention is to provide a filled food product that can be covered with any kind of pasta.

A further object of the present invention is to provide a filled food product that affords the provision of instant-made food products, while maintaining strict compliance with the original handicraft methods.

Yet another object of the present invention is to provide a filled food product that allows the filling components to be distributed in different positions, according to a wide variety of shapes and types of products.

These and other objects, as better explained hereafter, are fulfilled by a filled food product as defined in claim 1.

With these characteristics, the food product of the invention will afford the provision of filled products with fresh pasta envelopes, whose filling is composed of multiple food ingredients introduced into the same envelope of traditional, home-made form.

In a further aspect, the invention relates to a method of producing the food product, as defined in claim 4.

Advantageous embodiments of the invention are defined in accordance with the dependent claims.

### BRIEF DESCRIPTION OF THE DRAWINGS

Further features and advantages of the invention will be more apparent from the detailed description of a preferred, non-exclusive embodiment of a composite food product with double filling, which is described as a non-limiting example with the help of the annexed drawings, in which:

FIGS. 1A and 1B are lateral sectional views of a composite food product with double filling according to the invention;

FIG. 2 is a block diagram of the method of making the product of FIG. 1;

FIG. 3 is a schematic perspective view of a first embodiment of the method of the invention;

FIG. 4 is a schematic perspective view of a second embodiment of the method of the invention.

### DETAILED DESCRIPTION OF A PREFERRED EMBODIMENT

The accompanying figures show a composite food product with double filling, generally designated by numeral 1, which is mainly designed for preparation of dishes of high gastronomic quality.

Particularly, the food product 1 of the invention may be one of the Italian dumplings known as ravioli, panzerotti, tortelli, cappelletti or the lile and may be designed to be eaten either raw and cooked.

If the product 1 is intended for cooking, it may be namely designed to be either boiled, e.g. in water or broth or baked, cooked in a microwave oven or fried in oil.

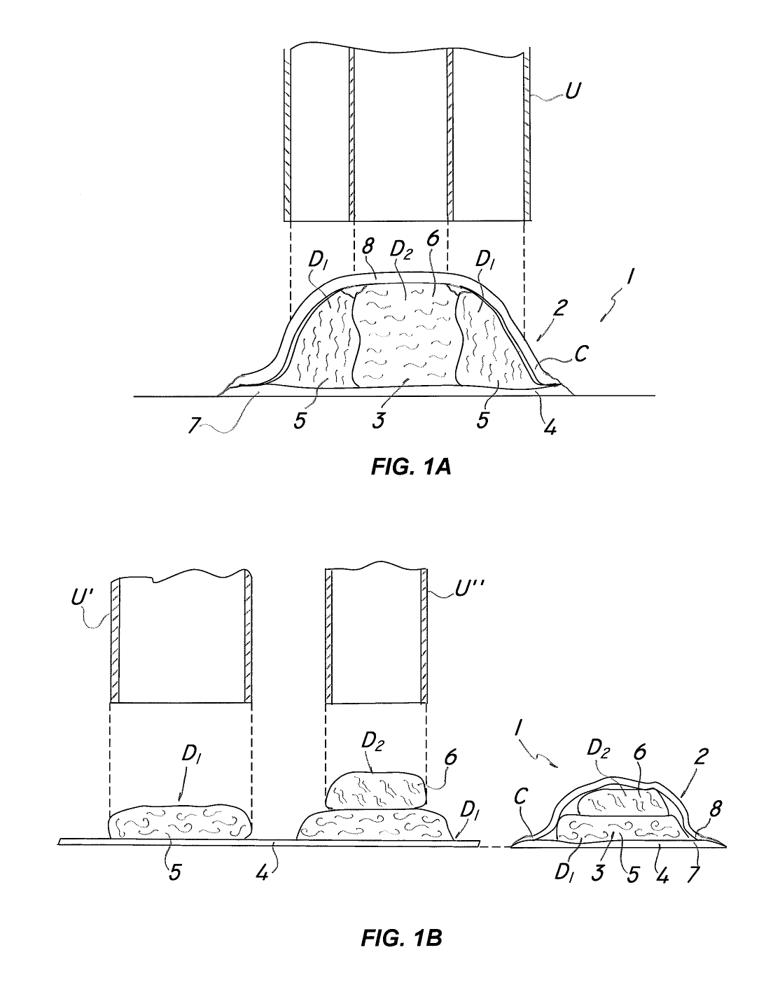

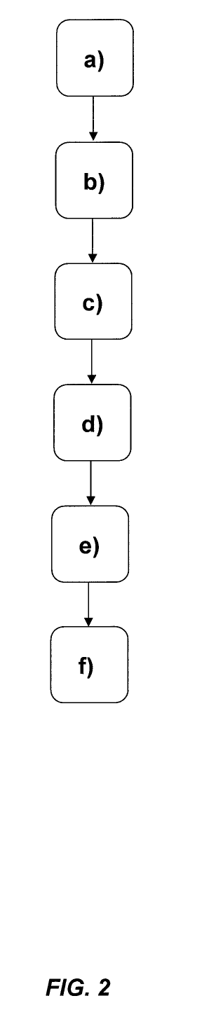

The composite food product, as best shown in FIGS. 1A and 1B essentially comprises an envelope 2 made of pasta, which encloses therein a filling 3 made of edible food raw materials.

For example, the envelope 2 may be formed from a sheet of pasta dough composed of soft-wheat flour, durum-wheat flour, eggs and possibly a very small amount of water. The sheet may have a thickness ranging from 0.5 to 2.5 mm, and preferably of about 1 mm.

The raw materials that form the filling may be selected from the group comprising, for example, meat, fish, eggs, cheese, cold cuts, vegetables, cereals, protein- and fat-based substances, flavors and spices, possibly added with seasonings, flavors and sauces, even though these cannot be easily combined according to traditional recipes.

The pasta envelope 2 may have a predetermined size and shape, allowing it to contain the filling 3, according to the particular type of food product 1 to be obtained.

According to a peculiar characteristic of the invention, the envelope 2 consists of at least one sheet 4 of fresh pasta and the filling 3 comprises at least one first dose D₁ of a first component 5 and at least one second dose D₂ of a second component 6 other than the first component. Particularly, the doses are distinct D₁, D₂, while being both enclosed within the same envelope 2.

The choice of fresh pasta and its base components shall allow the envelope 2 to optimally wrap the outer surface of the filling 3 with high surface adhesion, for almost perfect liquid tightness, even in boiling liquids, as required for cooking with no loss of filling 3. Furthermore, this will provide food products 1 with double filling having a characteristic taste, and faithfully reproducing the traditional regional gastronomy tastes.

Namely, the envelope 2 may be made up of a lower layer 7 and an upper layer 8 of fresh pasta, which are in mutually overlapped or juxtaposed relationship and are joined together along a substantially continuous peripheral edge C having a predetermined shape, in accordance with the type of desired product.

Conveniently, once the layers 7, 8 are joined along the peripheral edge C, the envelope 2 will be preferably substantially hermetic, i.e. substantially liquid-tight or upon boiling, such that it will not break during boiling and will not lose the filling 3.

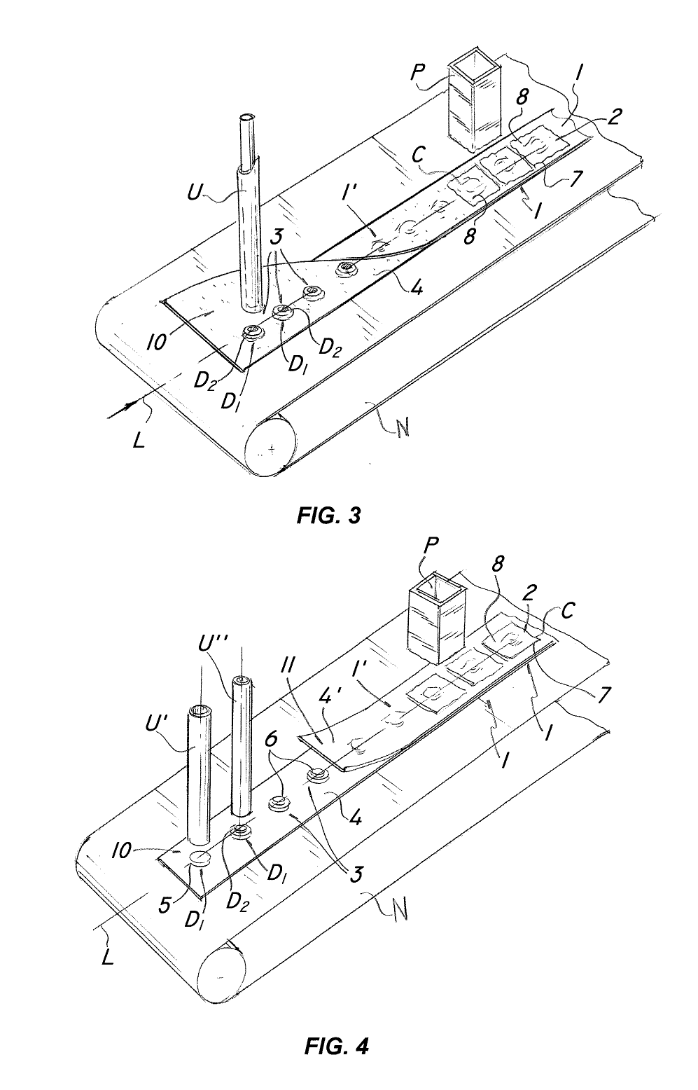

In a first embodiment of the envelope 2, as shown in FIG. 3, the layers 7, 8 may be formed from the same sheet 4 of fresh pasta, which is folded on itself along a longitudinal line L using a special ploughshare-shaped blade, not shown and known to the skilled person.

This embodiment is particularly suitable to make products 1 such as tortelli, cappelletti, panzerotti and the like.

As an alternative to this envelope 2, as shown in FIG. 4, the layers 7, 8 may consist of two distinct and separate sheets of fresh pasta 4, 4′ in mutually overlapped relationship. This embodiment is particularly suitable to make products such as ravioli and panzerotti.

In a preferred embodiment, the doses D₁, D₂ may be arranged in substantially concentric relationship.

Particularly, the doses D₁, D₂ may be laid on the lower layer 7 in concentric arrangement.

Furthermore, the doses D₁, D₂ may be laid on the lower layer 7 substantially at the same time, by coextrusion, using a double-tube nozzle U, as shown in FIGS. 1A and 3.

Alternatively, the doses D₁, D₂ may be arranged in substantially coplanar relationship.

Particularly, the doses D₁, D₂ may be laid on the lower layer 7 at successive times, using single-tube nozzles U′, U″, although in substantially superimposed and substantially concentric positions 7, 8, as shown in FIGS. 1B and 4.

Once the doses D₁, D₂ have been laid on the lower layer 7, a portion of the sheet 4 may be folded thereon along the line L, or a second sheet 4′ may be laid thereon, to form the upper layer 8 and define a semifinished product

Finally, the semifinished product 1′ may be cut to size using a forming and cutting tool P, such that the layers 7, 8 will be joined along a peripheral edge C and cut thereat to form a finished product 1.

Thus, the finished product will be closed in perfectly liquid-tight fashion, at its peripheral edge C.

Preferably, the doses D₁, D₂ may have their respective components 5, 6 ranging from 5% to 95%, preferably from 10% to 90% by weight, based on the total weight of the filling 3.

In a further aspect, the invention relates to a method of making food products.

Particularly, the method comprises preparing an envelope 2 made of fresh pasta dough and introducing a filling 3 made of edible raw materials 5, 6 therein.

In a preferred embodiment, the method comprises a first step a) in which a lower layer of fresh pasta 7 is prepared.

In the next step b), a first filling component 5 and at least one second filling component 6, other than the first component 5, are prepared.

In the following step c), a first dose D₁ of the first component 5 and a second dose D₂ of the second component 6 are laid on the lower layer 7.

Conveniently, the method comprises a step d) in which an upper layer 8 of fresh pasta is prepared and laid over the lower layer 7 to cover the doses D₁, D₂.

In the next step e), the lower layer 7 and the upper layer 8 are joined along a substantially continuous peripheral edge C, whose shape matches the shape of the finished product 1 to form a filled semifinished product 1′.

In step f), the filled semifinished product 1′ is cut along the edge C to form the finished food product 1.

Particularly, the semifinished product 1′ may be cut proximate to the peripheral edge C to obtain a shape of the finished product 1 that is slightly different from that of the edge itself.

Conveniently, in step c), the doses are laid on the lower layer 7 at the same time, as shown in FIG. 3, or at successive times, as shown in FIG. 4.

Conveniently, the first component 5 and the second component 6 may be heated to a predetermined temperature Tᵣ substantially at the same time as they are laid on the lower layer 7.

The first dose D₁ and the second dose D₂, as best shown in FIG. 3, may be substantially concentric and laid by simultaneous coextrusion of the first component 5 and the second component 6.

Alternatively, the first dose and the second dose, as best shown in FIG. 3, may be substantially concentric and laid by coextruding one of the first component 5 and second component 6 later than the other of the second component 6 or the first component 5.

Conveniently, as best shown in FIG. 3, the lower layer 7 and the upper layer 8 may be obtained by folding a single sheet 4 of fresh pasta on itself.

Alternatively, as best shown in FIG. 4, the lower layer 7 and the upper layer 8 may be obtained from two distinct sheets 4, 4′ of fresh pasta.

The two sheets 4, 4′ may be in at least partially overlapped relationship. Particularly, the filling 3 may be laid on a sheet 4 of fresh pasta, whereas the other sheet 4′ of fresh pasta may be laid at least partially over the first sheet 4 and totally over the filling 3.

Particularly, single-sheet food products 1 are made by forming the lower layer 7 and the upper layer 8 by folding a single sheet of fresh pasta 4 on itself.

Alternatively, double-sheet food products 1 are made by forming the lower layer 7 and the upper layer 8 by laying two distinct sheets of fresh pasta 4, 4′ in overlapped relationship.

In a continuous process, the lower layer 8 and the upper layer 9 are both in the form of strips 10, 11, as shown in FIGS. 3 and 4, and are fed in a substantially longitudinal direction L. Each of the strips 10, 11 is fed in the direction L by a moving conveyor surface, such as a closed-loop belt conveyor N.

Conveniently, as shown in FIG. 3, the doses D₁, D₂ may be laid by simultaneous coextrusion of the first component 5 and the second component 6 on one of the strips 10 in predetermined positions along the longitudinal extent thereof, and may be later covered by the other strip 11.

Furthermore, as shown in FIG. 4, a dose D₁ may be laid on one of the strips 10 in a predetermined position and the other dose D₂ is laid above the dose D₁ in a substantially concentric position.

The latter dose may be laid later than the dose D₁ laid on the strip 10.

The overlapped doses D₁, D₂, as shown in FIG. 4, may be later covered by the other strip 11.

The above disclosure clearly shows that the composite food product with double filling and the method of the invention fulfill the intended objects and particularly meet the requirement of providing a filled food product comprising at least one sheet of fresh pasta and having a high organoleptic value.

The filled food product and method of the invention are susceptible to a number of changes or variants, within the inventive concept disclosed in the annexed claims.

All the details thereof may be replaced by other technically equivalent parts, and the materials may vary depending on different needs, without departure from the scope of the invention.

While the filled food product and method of the invention have been described with particular reference to the accompanying figures, the numerals referred to in the disclosure and claims are only used for the sake of a better intelligibility of the invention and shall not be intended to limit the claimed scope in any manner.

1. A filled food product, such as Italian dumplings known as ravioli, cappelletti, tortelli, panzerotti and the like, comprising an envelope (2) made of pasta, enclosing therein a filling (3) made of edible raw materials, characterized in that the filling (3) comprises at least one first dose (D₁) of a first component (5) and at least one second dose (D₂) of a second component (6) other than the first component, said components (5, 6) being selected from the group comprising meat, fish, eggs, cheese, cold cuts, vegetables, cereals, protein- and fat-based substances or combinations thereof, possibly added with seasonings, flavors and sauces, said doses (D₁, D₂) being distinct and both enclosed within said envelope (2), said envelope (2) being made up of a lower layer (7) and an upper layer (8), the layers, which are in mutually facing relationship and joined together along a substantially continuous peripheral edge (C) having a predetermined shape, said envelope (2) being closed along said peripheral edge (C) in substantially liquid-tight fashion or upon boiling.

2. Product as claimed in claim 1, wherein said doses (D₁, D₂) are substantially concentric and lie over said lower layer (7).

3. Product as claimed in claim 1, wherein said doses (D₁, D₂) are substantially coplanar and lie above said lower layer (7).

4. Product as claimed in claim 1, wherein said doses (D₁, D₂) are in substantially overlapped relationship.

5. A product as claimed in claim 1, wherein the doses (D₁, D₂) have their respective components (5, 6) ranging from 5% to 95%, preferably from 10% to 90% by weight, based on the total weight of the filling (3).

6. A method of making filled food products (1), such as Italian dumplings known as ravioli, cappelletti, tortelli, panzerotti and the like, which comprises preparing an envelope (2) made of fresh pasta and introducing therein a filling (3) made of edible raw materials, wherein the method comprises the steps of:
a) preparing a lower layer (7) of fresh past, extending in a substantially horizontal plane;
b) preparing a first filling component (5) and at least one second filling component (6) other than the first component (5), wherein said components (5, 6) are selected from the group comprising meat, fish, eggs, cheese, cold cuts, vegetables, cereals, protein- or fat-based substances or combinations thereof, possibly added with seasonings, flavors and sauces and without the addition of pasta;
c) laying a first dose (D₁) of said first component (5) and a second dose (D₂) of said second component on said lower layer (7), in a direction substantially perpendicular to said horizontal plane;
d) preparing an upper layer (8) of fresh pasta and laying it over said lower layer (7) to cover said doses (D₁, D₂);
e) joining said layers (7, 8) along a substantially continuous peripheral edge (C) which matches the shape of the finished product (1) to form a filled semifinished product (1′) which is closed in substantially liquid-tight fashion or upon boiling;
f) cutting said filled semifinished product (1′) along said edge (C) to form the finished food product (1);
wherein said doses (D₁, D₂) are laid on said lower layer (7) at the same time or at successive times.

7. Method as claimed in claim 6, wherein said first dose (D₁) and said second dose (D₂) are substantially concentric and laid by simultaneous coextrusion of said components (5, 6).

8. Method as claimed in claim 6, wherein said first dose (D₁) and said second dose (D₂) are substantially concentric and laid by extrusion of each component (5, 6) at successive times.

9. Method as claimed in claim 6, wherein said lower layer (7) and said upper layer (8) are obtained from the same sheet (4) of fresh pasta folded on itself.

10. Method as claimed in claim 6, wherein aid lower layer (7) and said upper layer (8) are obtained from two distinct sheets (4, 4′) of fresh pasta folded on itself.

11. Method as claimed in claim 9, wherein said lower layer (7) and said upper layer (8) are both in the form of strips (10, 11) and are fed in a substantially longitudinal direction.

12. Method as claimed in claim 11, wherein said doses (D₁, D₂) are laid by simultaneous coextrusion of said components (5, 6) on one (10) of said strips in predetermined positions along the longitudinal extent thereof, and are later covered by the other (11) of said strips.

13. Method as claimed in claim 11, wherein one of said doses (D₁) is laid on one (10) of said strips in a predetermined position, the other of said doses (D₂) being laid in substantially superimposed and concentric relationship to said one dose (D₁) at a later time, said mutually overlapping doses (D₁, D₂) being later covered by the other (11) of said strips.
